(19) United States
(12) Patent Application Publication
(10) Pub. No.: US 2003/0021495 A1
(43) Pub. Date: Jan. 30, 2003

(54) Fingerprint biometric capture device and method with integrated on-chip data buffering

(76) Inventor: Ericson Cheng, Santa Clara, CA (US)

Correspondence Address: FLEHR HOHBACH TEST ALBRITTON & HERBERT LLP, Suite 3400, Four Embarcadero Center, San Francisco, CA, 94111-4187, US

(21) Appl. No.: 10/099,558

(22) Filed: Mar. 13, 2002

Related U.S. Application Data
(60) Provisional application No. 60/305,120, filed on Jul. 12, 2001.

(51) Int. Cl. G06K 7/00; G06K 9/00

(52) U.S. Cl. 382/312; 382/124

(57) ABSTRACT

Invention provides a fingerprint biometric capture sensor device and method for capturing and either reconstructing fingerprint image or information concerning fingerprint without actually performing fingerprint image reconstruction. In another aspect, fingerprint biometric capture sensor device is integrated with on-chip data buffering. In another aspect, sensor device is integrated with on-chip processor. In another aspect, invention provides a fingertip sensor system including: fingertip sensor device generating analog first electrical signal representing feature of fingertip in response to placing fingertip in proximity with sensor device; analog-to-digital converter coupled with and receiving analog first electrical signal from sensor device and converting first electrical signal to a digital second electrical signal; at least one buffer coupled with and receiving digital second electrical signal from analog-to-digital converter and storing information corresponding to at least a portion of digital second electrical signal therein; and logic controlling operation of sensor, analog-to-digital converter, buffer, and host interface circuit.

### RELATED APPLICATIONS

Priority is claimed under 35 U.S.C. 120 and/or 35 U.S.C. 119(e) to U.S. Provisional Patent Application Serial No. 60/305,120 filed Jul. 12, 2001 for System, Method, Device And Computer Program For Non-Repudiated Wireless Transactions, incorporated herein by reference.

### FIELD OF THE INVENTION

This invention relates generally to system, apparatus, and method for sensing and imaging fingerprints, and also to the field of solid state devices and integrated circuits; and more particularly to compact integrated circuit devices and associated hardware and software for sensing and imaging such fingerprints and for extracting fingerprint minutia and reconstructing fingerprints from electronic sensors.

### BACKGROUND

Fingerprints have been used for centuries to identify and/or verify individuals. In the past few decades, this process has been automated using computers and computer programs and embedded algorithms running on such computers, which analyze an image of a person's fingerprint and automatically compare it to a candidate or reference image (or to one or more databases storing such candidate or reference images) to either confirm or rule out a match of the fingerprint under test with the reference.

While the description provided herein focuses on human fingerprints, it will be understood that the methods and structures described herein may also or alternatively be used in connection with other than human finger prints, such as for example, with human footprints or portions thereof, and with animal (or other non-human) hand, paw, or finger prints of various types, such as for example the hand or fingerprints of other primates. Further references herein to fingerprints, human or otherwise, shall be intended to include the broader set of finger or body print portion biometrics described above.

There are many commercially available ways to image a human fingerprint for subsequent processing by a computer or other intelligent device. Such methods include optical devices (for example, optical devices of the type made by Identix), capacitive sensors (for example, capacitive sensors made by Infineon), electronic-field or e-field sensors (such as those sensors made by Authentec), and thermal sensing devices (such as the sensing devices made by Atmel). With the exception of optical devices, these sensors are by and large silicon-based integrated circuits.

The currently available set of commercial fingerprint devices fall into two categories: (i) full-size placement sensors, and (2) typically smaller so-called swipe sensors. Placement sensors have an active sensing surface that is large enough to accommodate most of all of the interesting part of a finger at the same time. Generally, these have a rectangular shape of at least 100 mm and the finger is held stationary while it is being imaged.

Conventional swipe sensors generally use the same imaging principles as their larger placement counterparts. However, swipe sensors are too small to accommodate the entire finger at once. Instead, their typically thin rectangular shape allows them to capture only a small horizontal slice of the finger image at one time. The user is required to slide or swipe his finger downward across the sensor until all parts of the finger have been imaged, analogous to how a feed-through paper document scanner operates.

Swipe sensors offer the opportunity for much lower manufacturing cost due to their reduced size, but they pose unique problems regarding how to reconstruct or generate the fingerprint image from the raw partial scan(s) and also in handling all the data that the devices generate, particularly when capture and processing is to be performed in real-time.

FIG. 1 shows an example of a conventional fingerprint swipe capture device 1. The device has a sensor 2 for imaging a finger 4. The area that is visible by the sensor is a called a “frame.” Sensor 2 can be used for imaging subjects that are larger than its frame. This is accomplished by translating the subject over sensor 2 and capturing partial (preferably overlapping) images of the subject. These partial images of the subject can be read from input/output port 3 and assembled by software running on the host computer to reconstruct an image of the subject. Thus, the sensor can be used to image a fingerprint by sweeping the finger over the sensor.

FIG. 2 is a block diagram showing a typical example of a conventional fingerprint capture device, whether it be a full fingerprint placement device or a fingerprint swipe type device. It consists of a sensor 2, an analog-to-digital (A/D) converter 5, control logic 6, a host interface 7, and an input/output port 3. Sensor 2 (typically an array of transducers, which may be optical, capacitive, thermal, resistive, conductive, or the like) converts the topography (surface profiles or contours) of the ridges and valleys of a fingerprint into electrical signals 8, which are then digitized by A/D converter 5. The A/D converter's 5 output port 9 feeds host interface 7, which translates the data from its internal-logic format into the external interface format before sending it through the I/O interface 3, which couples to a host 10.

The transducers in the sensor array are usually organized into rows and columns in a regular array and accessed a row at a time. Control Logic 6 selects a row from the sensor array. The outputs of the selected row are fed or communicated into the A/D converter to be digitized. After the selected row has been digitized and the data read by the host, the next row is selected for conversion. This procedure repeats for each row until all the rows in the frame have been converted. Then the cycle is repeated to capture the next frame.

The finger is in motion while it is being scanned. This results in a distortion of the partial image. The faster the finger moves, the greater the distortion. The maximum sweep speed for a given tolerated distortion is limited by the A/D converter speed and the rate at which the host can read the A/D Converter. The amount of distortion or translation tolerated could be represented by a distance d, which is the distance the finger has traveled in the time t, where the time t is the time it takes to digitize the frame. The maximum sweep is related to the ratio of distance to time (d/t). Higher sweep rates therefore can be achieved by reducing time t.

The less time it takes to capture a frame, the faster the finger may sweep without exceeding a specified amount of distortion. Increasing the maximum sweep speed is desirable because it improves the usability of the sensor by allowing users of the fingerprint capture device to sweep their fingers at arbitrary speeds. Users would not be required to slowly sweep their fingers over the sensor or otherwise pay undo attention to how they swipe.

Generally the integrated A/D converter can be made fast enough to meet a desired sweep speed. However, the host's read rate typically varies from system to system. It is often the case that the A/D converter can produce data at a burst-rate faster than the host can read it. The A/D converter can't proceed with the next conversion until the host has read the data from the current conversion. Therefore in some systems, the host's read rate becomes the primary limiting factor of the maximum sweep rate.

The effect of the host's read rate on the frame capture time can be reduced by inserting a buffer between the A/D converter and the host as shown in FIG. 3. The buffer decouples the A/D converter's output burst-rate from the host's read rate. A buffer with the capacity to store a minimum of one frame of data from the A/D converter is called a “frame buffer.” A frame buffer allows the A/D converter to run at its maximum frame capture rate because the A/D converter can convert the entire frame without having to wait for the host to read any of the data.

The maximum sweep rate is no longer dependent on the host's ability to keep up with the burst rate of the A/D converter. Instead the sweep rate is limited by how much data the host can read from one frame to the next, which is a much less demanding on the host.

There are at least two conventional approaches to fingerprint scanning devices and buffering. The first approach (See FIG. 2), which is the most common implementation, doesn't use any buffering between the A/D converter and the host. However, the lack of a buffer potentially sacrifices sweep speed for reduced cost.

The second approach (See FIG. 3) uses an External Buffer Circuit 11, which consists of an external memory buffer 12, external control logic 13, buffer input interface 14, and buffer output interface 15. The external memory buffer 12 is large enough to store one or more frames. The external control logic 13 manages the buffer input interface 14, the memory buffer 12, and the buffer output interface. The buffer input interface 14 receives data from the Input/Output port 3 of the fingerprint capture device 1 and loads it into the memory buffer 12. The buffer output interface 15 reads the memory buffer 12 and outputs the data to the host 10. This second approach is substantially more expensive and uses much more space.

### BRIEF DESCRIPTION OF THE DRAWINGS

FIG. 1 is a diagrammatic illustration showing features of a typical conventional fingerprint swipe capture device.

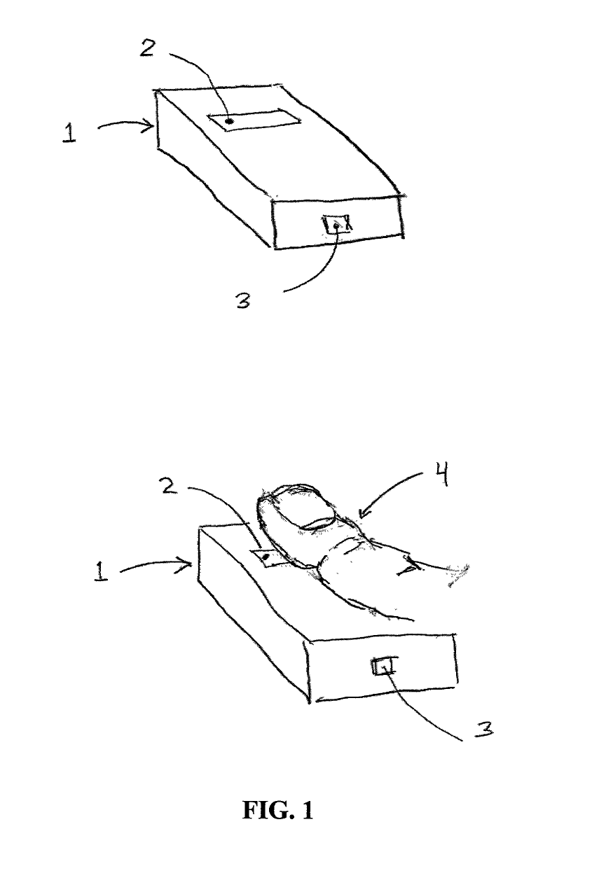

FIG. 2 is a diagrammatic illustration showing a block diagram of a typical conventional fingerprint capture device.

FIG. 3 is a diagrammatic illustration showing the manner in which the effect of a host processor read rate on the frame capture time can be reduced by inserting a buffer between the analog-to-digital converter and the host.

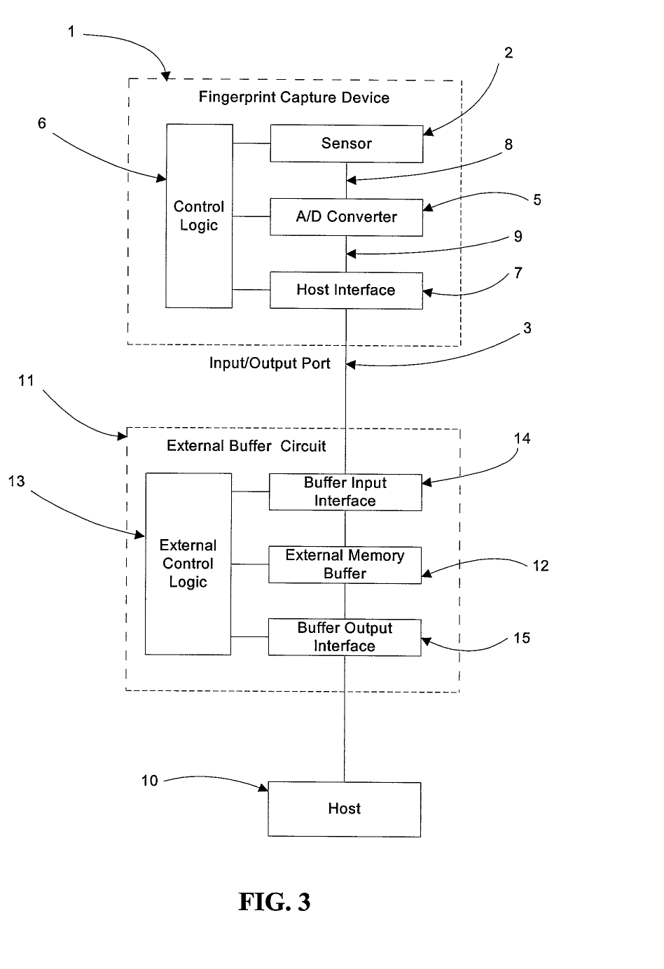

FIG. 4 is a diagrammatic illustration showing a block diagram of an embodiment of a fingerprint capture device with an integrated buffer.

FIG. 5 is a diagrammatic illustration showing a block diagram of an embodiment of the integrated buffer.

FIG. 6 is a diagrammatic illustration showing a block diagram of an embodiment of the control block or logic of the capture device.

### SUMMARY

In one aspect, the invention provides a fingerprint biometric capture sensor device and method for capturing and either reconstructing a fingerprint image or information concerning the fingerprint without actually performing a fingerprint image reconstruction. In another aspect, the fingerprint biometric capture sensor device is integrated with on-chip data buffering. In another aspect, the sensor device is integrated with an on-chip processor.

In another aspect, the invention provides a fingertip sensor system including: a fingertip sensor device generating an analog first electrical signal representing a feature of the fingertip in response to placing the fingertip in proximity with the sensor device; an analog-to-digital converter coupled with and receiving the analog first electrical signal from the sensor device and converting the first electrical signal to a digital second electrical signal; at least one buffer coupled with and receiving the digital second electrical signal from the analog-to-digital converter and storing information corresponding to at least a portion of the digital second electrical signal therein; and logic controlling operation of the sensor, the analog-to-digital converter, the buffer, and the host interface circuit.

In another aspect, the invention provides a communication device including: a fingerprint biometric sensor system for determining and authenticating an identity of a user of the communication device; a transmitter for transmitting a first data including identity data for the user; a receiver for receiving second data; the fingerprint biometric sensor system including: a fingertip sensor device generating an analog first electrical signal representing a feature of the fingertip in response to placing the fingertip in proximity with the sensor device; an analog-to-digital converter coupled with and receiving the analog first electrical signal from the sensor device and converting the first electrical signal to a digital second electrical signal; at least one buffer coupled with and receiving the digital second electrical signal from the analog-to-digital converter and storing information corresponding to at least a portion of the digital second electrical signal therein; and logic controlling operation of the sensor, the analog-to-digital converter, the buffer, and the host interface circuit.

In another embodiment, the invention provides a method for reducing power consumption of a fingerprint capture device, the method including: forming a fingerprint sensor on a first substrate; forming device control and signal processing circuits for generating and converting an analog sensor signal carrying fingerprint information to a digital signal on the same first substrate, the signal processing circuits including an analog-to-digital converter; and forming a buffer memory on the same first substrate, the buffer memory including a plurality of input ports selected to match a bit-width of an analog-to-digital converter.

In another aspect, the invention provides a method for reducing power consumption of a fingerprint capture device, the method including: powering a fingerprint sensor disposed on a first substrate to generate an analog detected signal in response to an externally applied fingerprint stimulus; receiving the detected signal and processing the detected signal within processing circuits formed on the first substrate to generate an v×p-bit digital signal carrying fingerprint information; and storing the n-bit fingerprint information in a buffer memory disposed on the first substrate, the buffer memory including a number n of input ports to match the v×p-bit width of the v-bit×p-bit digital fingerprint signal; the powering, generating, receiving, and storing on the common first substrate and the matching of the v-bit×p-bit widths reducing power consumption of the device relative to devices having an external buffer on a substrate other than the first substrate.

### DETAILED DESCRIPTION

Various aspects, advantages, features, and embodiments of the invention are now described relative to the drawings.

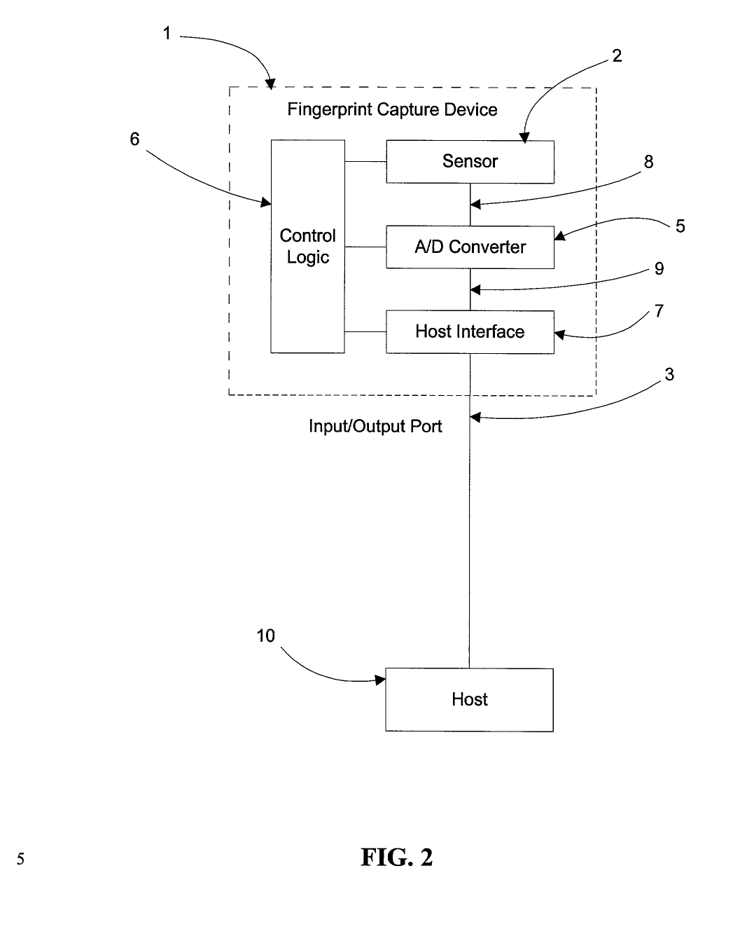

In one aspect, the invention provides a fingerprint capture device integrated on a single common substrate with a buffer. Integrating the buffer into the fingerprint capture device reduces the cost, size, and power consumption of the fingerprint capture system 1, 11. The buffers and associated control logic can be integrated into the silicon sensor with little or no increase in cost per die. The fingerprint capture device with an integrated buffer is comparable in size and cost to a bufferless device 1 (See FIG. 2). However, the savings in cost and space from eliminating the external buffer and control logic can reach 50% to 95%. The power consumption of the integrated buffer can be less than that of an external buffer. The input ports of the internal buffer can be made to match the port width of the A/D converter for more efficient data flow and improved performance. These enhancements to the sensor are advantageous for applications where space and power is a premium such as on a cellular phone, personal digital assistant, or other portable device.

It is also noted that the inventive structure and method of the present invention provides significant improvements to the current state of the art because it offers improved performance when connecting such sensor devices and systems to a host computer (such as a host computer within a portable information appliance or communication device) and significant size and cost advantages over other solutions to handling the high data rate.

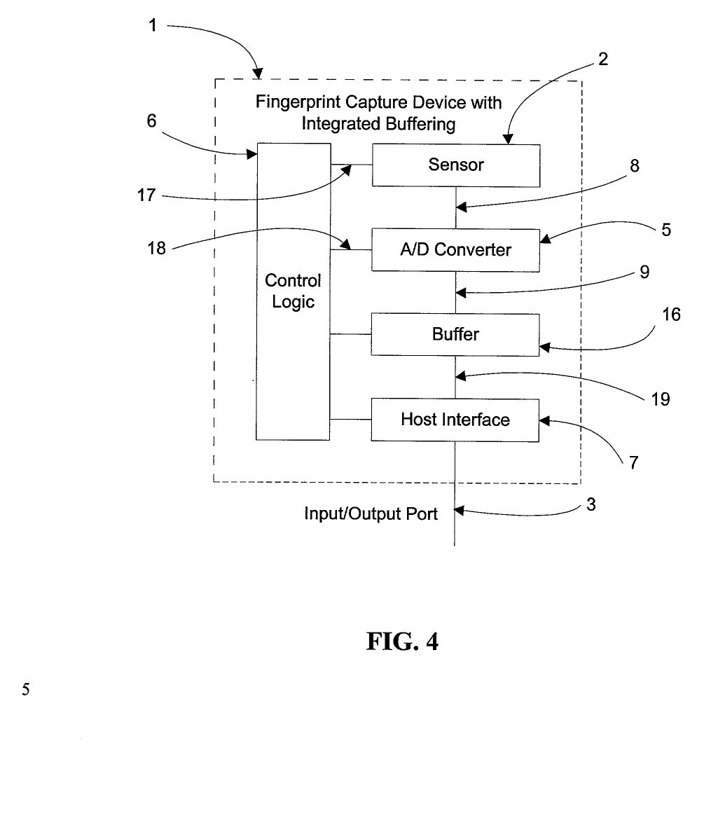

FIG. 4 is a diagrammatic illustration showing a block diagram of an embodiment of a fingerprint capture device with an integrated buffer. The fingerprint capture device comprises a sensor 2, an A/D converter 5, a buffer 16, and control logic 6, all integrated on a single piece of silicon (or other substrate).

Sensor 2 comprises a sensor array, control inputs, and transducer outputs. The sensor array is an m×n array of transducers with m rows and n columns. Control inputs 17 connect to the control logic 6. There are transducer outputs 8 which feed the A/D converter 5.

The A/D converter 5 comprises control inputs 18, analog inputs 8, and output port 9. The control inputs 18 connect to the control logic 6. There are u analog inputs 8, which come from the sensor 2 and feed the A/D converter 5. The digitized values are sent out the A/D converter output port 9, which is v×p-bits wide.

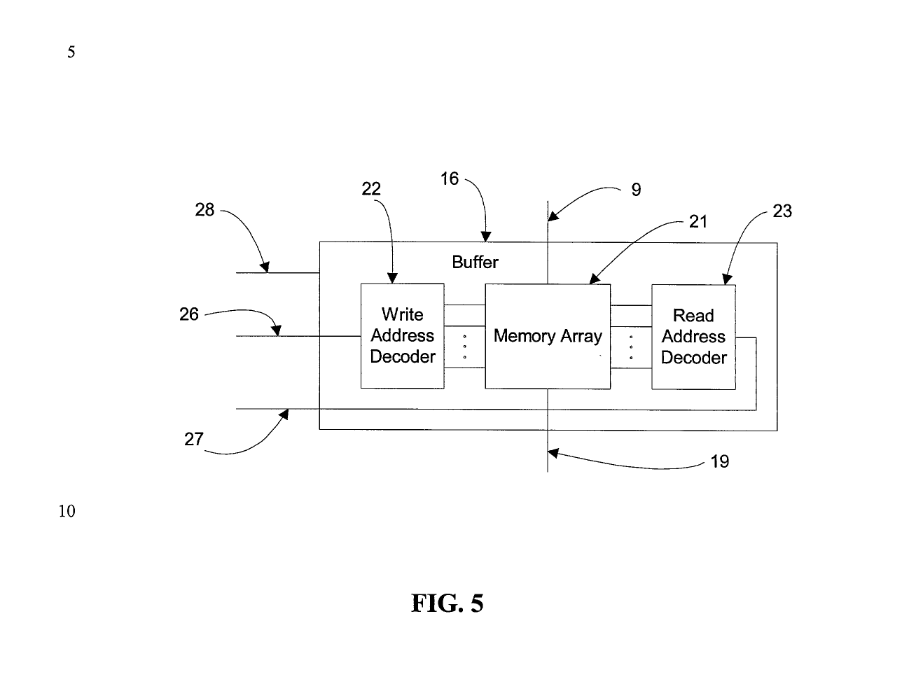

FIG. 5 is a block diagram of an embodiment of buffer 16. The buffer comprises a memory array 21, a write-address decoder 22, a read-address decoder 23, a data input port 9, a data output port 19, a write-address input port 26, a read-address input port 27, and a control input port 28.

The memory array 21 is of size h×m×n×p-bits, where h is the number of frames the buffer can store, m is the number of rows in the sensor array, n is the number of columns in the sensor array, and p is the data width of the digitized value of a single transducer element.

The data input port 9 of the buffer 16 is v×p-bits wide and connects the output of the A/D converter 5 to the memory array 21. The width of the data input port 9 typically matches the output data width of the A/D converter 5. Data is written into the memory array via the data input port 9. The memory array 21 can receive data as fast as the A/D converter 5 can generate it.

The data output port 19 of the buffer 16 is q-bits wide and connects the memory array 21 to the host interface block 7. Data is read from the memory array 21 via the data output port 19.

The dual-porting of the memory array allows it to be simultaneously written by the A/D converter 5 and read by the host interface 7.

The write-address input port 26 comes from the control block 6 and feeds the write-address decoder 22, which decodes the address to select a block within the memory array 21 to be loaded from the A/D converter 5 through data input port 9. The block may be single element of size p-bits or the block may multiple elements. Write-enable signals, which are part of the control input port 28, strobe the data from the A/D converter 5 into the selected memory block.

The read-address input port 27 comes from control block 6 and feeds the read-address decoder 23, which decodes the address to select a block within the memory array 21 to be read via the data output port 19. The block may be a single element of size q-bits or a block may be a multiple of q-bits. Read-enable signals, which are part of the control input port 28, enable the selected memory block to drive the data output port 19.

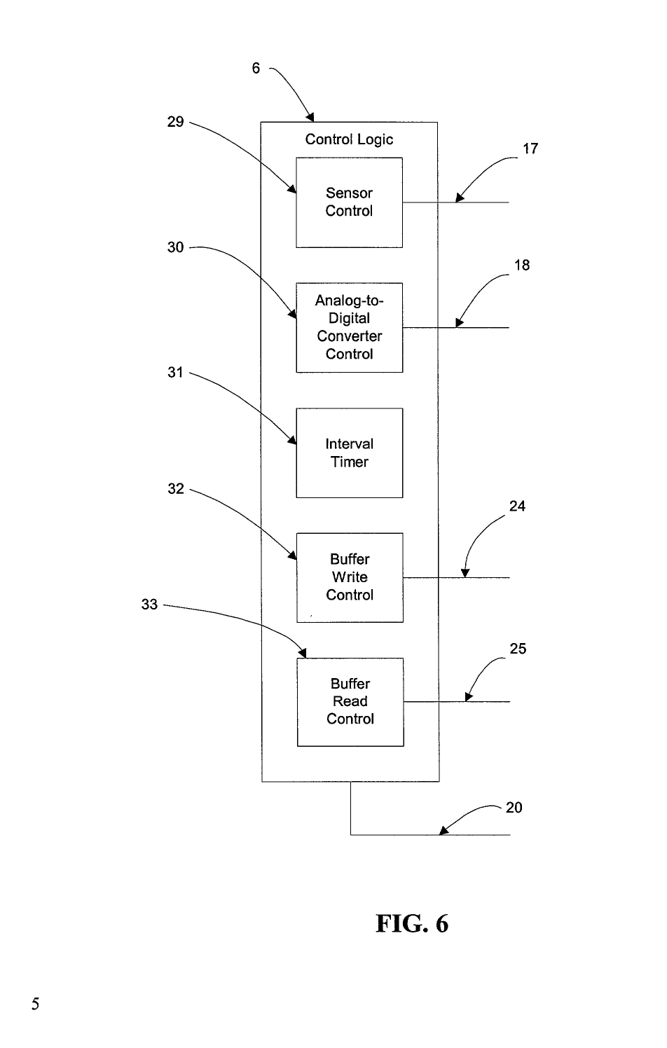

FIG. 6 is a block diagram of the control block 6, which consists of a sensor control 29, an A/D converter control 30, an interval timer 31, a buffer-write control 32, and a buffer-read control 33.

The sensor control 29 generates addresses and control inputs 17 to the sensor 2. The sensor control also connects to the A/D converter control 30. The A/D control 30 generates controls signals 18 into the A/D converter and the sensor array control 29 necessary to digitize a frame of data. Typically the A/D converter will run until a frame of data is loaded into the buffer.

The interval timer 31 can be used to trigger the A/D conversion of the next frame. The interval timer 31 makes it possible to capture frames at a uniform rate and continue filling additional frame buffers without host intervention. Without the ability to automatically fill the frame buffers at some set interval, there is little or no benefit to having more than one frame buffer.

Buffer Write Control 32 generates write addresses 26 and write strobes 24. The addresses 26 feed the write-address decoder 22 of the buffer 16. The write strobes 24 are inputs into the memory array 21 and cause output 9 of the A/D converter 5 to be loaded into the selected memory block. The Buffer Write Control 32 sequentially fills the memory array 21 from the A/D converter 5. The addresses 26 reset to the beginning of the array when the end of the memory array 21 is reached. The loading of the memory array 21 will pause if the memory array is full.

Buffer Read Control 33 generates read addresses and read strobes. The addresses 27 feed the read-address decoder 23 of the buffer 16. The read strobes 25 are inputs into the memory array 21 and enable the outputs of the selected memory block to drive the output port 19 of the memory array 21. The Read Control 33 sequentially empties the memory array 21 into the host interface 7. The addresses reset to the beginning of the array when the end of the memory array 21 is reached. The reading of the memory array 21 will pause if the memory array 21 is empty.

Host Interface 7 has an input port 19, a bi-directional I/O port 3, and control signals 20. The purpose of the Host interface block is to convert between the internal logic format and the interface to the external host processor. The Host Interface 7 generates requests to the buffer read control block 33 in response to the host processor read access via the bi-directional I/O port 3. The input port 19 is q-bits wide and receives data from output of the buffer 16. This input data is formatted by the data translation block into the appropriate output format for the bi-directional I/O port 3, which provides an interface to the host processor. This bi-directional I/O port 3 could be implemented as an 8-bit parallel interface, Universal Serial Bus, Serial Peripheral Interface, or other interface, bus, or interconnects as are known in the art.

Having described numerous aspects of the sensor system and device, it will be appreciated that the sensor system may be provided with or integrated within numerous device types where fingerprint or other biometric scanning and extraction are desired. For example, in one embodiment, the inventive sensor and sensor system are provided integral with or attached to a personal data assistant (PDA). Attachment, may for example be via a wire or cable, or more desirably via a plug. In one embodiment, using a PDA such as the Palm, Compaq IPAQ, Handspring, or Sony Clie, the sensor system may plug in via an available accessory slot and connection. In another embodiment, the inventive sensor and sensor system are provided integral with or attached to a mobile telephone, cellular telephone or other communication device. In each of these embodiments, the small and compact size of the sensor and sensor system permit such integration and attachment.

An external surface of either the attached unit or the case of the PDA, phone, or the like, includes an aperture through which a sensing surface of the sensor device is exposed, permitting static placement of the fingertip or a swiping motion of the fingertip over the surface of the swipe sensor.

Furthermore, when provided in conjunction with such PDA, communication devices, or other information appliance, the sensor system host processor may be a processor of the PDA, communication device, or other information appliance; or, a separate host may be utilized; or, the host may be integrated within the sensor itself so that the sensor and its integrated components comprise the entire system. When separate host processors are utilized they may be configured for interoperability or to provide a communication path for exchanging commands and/or data.

The foregoing description, for purposes of explanation, used specific nomenclature to provide a thorough understanding of the invention. However, it will be apparent to one skilled in the art in light of the description provided that the specific details are not required in order to practice the invention. Thus, the foregoing descriptions of specific embodiments of the present invention are presented for purposes of illustration and description. They are not intended to be exhaustive or to limit the invention to the precise forms disclosed. Obviously many modifications and variations are possible in view of the above teachings.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents. All patents, publication, or other references referred to herein are hereby incorporated by reference.

We claim:

1. A fingertip sensor system comprising:
a fingertip sensor device generating an analog first electrical signal representing a feature of said fingertip in response to placing said fingertip in proximity with said sensor device;
an analog-to-digital converter coupled with and receiving said analog first electrical signal from said sensor device and converting said first electrical signal to a digital second electrical signal;
at least one buffer coupled with and receiving said digital second electrical signal from said analog-to-digital converter and storing information corresponding to at least a portion of said digital second electrical signal therein; and
logic controlling operation of said sensor, said analog-to-digital converter, said buffer, and said host interface circuit.

2. The system in claim 1, wherein said system further comprising:
an input/output port for communicating with an external device; and
a host interface circuit coupled between said buffer and said input/output port to retrieve said stored information from said buffer and communicate a digital electrical signal to said external device via said input/output port.

3. The system in claim 2, wherein said external device comprises a host.

4. The system in claim 3, wherein said host comprises a processor.

5. The system in claim 1, wherein said buffer stores said information only transiently.

6. The system in claim 1, wherein said buffer comprises a frame buffer.

7. The system in claim 1, wherein said sensor device and said buffer are formed on a single common integrated circuit substrate.

8. The system in claim 2, wherein said sensor device, said analog-to-digital converter, said logic, said host interface circuit, and said buffer are formed on a single common integrated circuit substrate.

9. The system in claim 2, wherein said buffer receives a control signal from control logic at a control input port, and further comprises a write address decoder receiving a write memory address at a write-address input port, a read address decoder receiving a read memory address at a read-address input port, and a memory array receiving first data at a memory array input port and communicating second data at a memory array output port.

10. The system in claim 7, wherein said integrated circuit substrate comprises silicon.

11. The system in claim 7, wherein said integrated circuit substrate comprises gallium arsenide.

12. The system in claim 7, wherein said integrated circuit substrate comprises a semi-conducting material.

13. The system in claim 1, wherein said sensor device comprises a fingertip placement sensor device.

14. The system in claim 1, wherein said sensor device comprises a fingertip swipe sensor device.

15. The system in claim 1, wherein said at least one buffer comprises a single buffer.

16. The system in claim 1, wherein said at least one buffer comprises a plurality of buffers.

17. The system in claim 2, wherein said at least one buffer comprises a plurality of frame buffers.

18. The system in claim 2, wherein said sensor device comprises a fingertip placement sensor device and said buffer includes a memory array for storing a two-dimensional array of digitized samples extracted from said placement sensor device.

19. The system in claim 2, wherein said sensor device comprises a fingertip swipe sensor device and said buffer includes a memory array for storing a one-dimensional array of digitized samples extracted from said fingertip swipe sensor device.

20. The system in claim 10, wherein said sensor device comprises a sensor transducer array, at least one control signal input port, and at least one sensor transducer array output port for communicating at least one output signal representing a characteristic of the sensed fingertip.

21. The system in claim 10, wherein said at least at least one sensor transducer array output port comprises a plurality of sensor transducer array output ports.

22. The system in claim 10, wherein said transducer array comprises a first plurality of transducer elements and said at least one output port comprises a second plurality of sensor transducer array output ports.

23. The system in claim 20, wherein said sensor device sensor array comprises an m-row×n-column array of transducers.

24. The system in claim 9, wherein for said sensor device and said control inputs are coupled with said control logic.

25. The system in claim 21, wherein said transducer outputs provide input analog signals to said analog-to-digital converter.

26. The system in claim 1, wherein said analog-to-digital converter comprises at least one control input, at least one analog input port 8, and at least one digital output port.

27. The system in claim 26 wherein said at least one control input connects to said control logic.

28. The system in claim 1, wherein said sensor device generates u-analog outputs and communicates said u-analog outputs to said analog-to-digital converter.

29. The system in claim 1, wherein said analog-to-digital converter generates a digital output signal at the analog-to-digital converter output port from a received sensor analog input signal at an input port.

30. The system in claim 29, wherein said digital output signal comprises a v×p-bits wide digital output signal.

31. The system in claim 30, wherein said buffer memory array is a two dimensional memory array of size h×m×n×p-bits, where h is the number of frames the buffer can store, m is the number of rows in the sensor array, n is the number of columns in the sensor array, and p is the data width of the digitized value of a single sensor device array transducer element.

32. The system in claim 31, wherein said data input port of the buffer comprises a v×p-bits wide data input port.

33. The system in claim 32, wherein said data input port connects the output of the analog-to-digital converter to the memory array.

34. The system in claim 33, wherein the width of said data input port is sized to match the output data width of the analog-to-digital converter.

35. The system in claim 34, wherein data is written into the memory array via a data input port.

36. The system in claim 35, wherein said memory array receives data as fast as the analog-to-digital converter generates the data.

37. The system in claim 36, wherein said data output port of the buffer is q-bits wide and connects the memory array to the host interface block.

38. The system in claim 37, wherein data is read from the memory array via the data output port.

39. The system in claim 38, wherein said memory array is dual-ported to allow simultaneously writes by the A/D converter and reads by the host interface.

40. The system in claim 39, wherein said memory array includes a write-address input port receiving a write address signal from said control block and feeds the write-address decoder, which decodes the address to select a memory array block within the memory array to be loaded from the A/D converter through the data input port.

41. The system in claim 40, wherein said memory array block is single element of size p-bits.

42. The system in claim 40, wherein said memory array block comprises multiple elements.

43. The system in claim 40, wherein said memory array block comprises multiple elements each having p-bits.

44. The system in claim 9, wherein said control logic generates write-enable signals that strobe the data from the analog-to-digital converter into the selected memory array block.

45. The system in claim 44, wherein said write-enable signals are part of the control input port.

46. The system in claim 40, wherein said memory array includes a read-address input port receiving a read address from the control block and feeds the read-address decoder, which decodes the address to select a block within the memory array to be read via the data output port.

47. The system in claim 46, wherein the memory array block is a single element of size q-bits.

48. The system in claim 46, wherein the memory array block comprises a multiple of q-bits.

49. The system in claim 46, wherein control logic generates read-enable signals, which are part of the control input port and enable the selected memory array block to drive the data output port.

50. The system in claim 49, wherein said control logic block comprises a sensor control, an analog-to-digital converter control, an interval timer, a buffer write control, and a buffer read control.

51. The system in claim 50, wherein said sensor control generates addresses and control inputs to the sensor.

52. The system in claim 51 wherein said sensor control further connects to the analog-to-digital converter control.

53. The system in claim 52, wherein said analog-to-digital converter control generates controls signals into the analog-to-digital converter and the sensor array control necessary to digitize a frame of data.

54. The system in claim 53, wherein the analog-to-digital converter will run until a frame of data is loaded into the buffer.

55. The system in claim 50, wherein said interval timer is used to trigger the A/D conversion of the next frame.

56. The system in claim 55, wherein said interval timer provides timing signals for the capture frames at a uniform rate and for the automatic switchover and automatic filling of additional frame buffers without host intervention.

57. The system in claim 56, wherein said ability to automatically fill the frame buffers at some set interval permits efficient use of multiple frame buffers.

58. The system in claim 50, wherein said buffer write control generates write addresses and write strobes.

59. The system in claim 58, wherein said write addresses feed the write-address decoder of the buffer.

60. The system in claim 58, wherein said write strobes are inputs into the memory array and cause output of the A/D converter to be loaded into the selected memory block.

61. The system in claim 58, wherein said buffer write control sequentially fills the memory array from the analog-to-digital converter.

62. The system in claim 61, wherein said write addresses reset to the beginning of the memory array when the end of the memory array is reached.

63. The system in claim 62, wherein loading of the memory array pauses if the memory array is full.

64. The system in claim 50, wherein said buffer read control generates read addresses and read strobes.

65. The system in claim 64, wherein said read addresses feed the read-address decoder of the buffer.

66. The system in claim 65, wherein said read strobes are inputs into the memory array and enable the outputs of the selected memory block to drive the output port of the memory array.

67. The system in claim 50, wherein said read control sequentially empties the memory array into the host interface.

68. The system in claim 65, wherein said read addresses reset to the beginning of the array when the end of the memory array is reached.

69. The system in claim 68, wherein the reading of the memory array will pause if the memory array is empty.

70. The system in claim 2, wherein said host interface includes an input port, a bi-directional I/O port, and control signals.

71. The system in claim 2, wherein said host interface responsibility includes converting between the internal logic format and the interface to the external host processor.

72. The system in claim 2, wherein said host interface generates requests to the buffer read control block in response to the host processor read access via the bi-directional I/O port.

73. The system in claim 70, wherein said input port comprises q-bits wide and receives data from the output of the buffer.

74. The system in claim 73, wherein said data output from said buffer is formatted by a data translation block into the appropriate output format for said bi-directional I/O port which provides an interface to the host processor.

75. The system in claim 74, wherein said bi-directional I/O port is implemented as an 8-bit parallel interface.

76. The system in claim 74, wherein said bi-directional I/O port is implemented as a Universal Serial Bus.

77. The system in claim 74, wherein said bi-directional I/O port is implemented as a serial peripheral interface.

78. A communication device comprising:
a fingerprint biometric sensor system for determining and authenticating an identity of a user of said communication device;
a transmitter for transmitting a first data including identity data for said user;
a receiver for receiving second data;
said fingerprint biometric sensor system including:
a fingertip sensor device generating an analog first electrical signal representing a feature of said fingertip in response to placing said fingertip in proximity with said sensor device;
an analog-to-digital converter coupled with and receiving said analog first electrical signal from said sensor device and converting said first electrical signal to a digital second electrical signal;
at least one buffer coupled with and receiving said digital second electrical signal from said analog-to-digital converter and storing information corresponding to at least a portion of said digital second electrical signal therein; and
logic controlling operation of said sensor, said analog-to-digital converter, said buffer, and said host interface circuit.

79. The communication device in claim 78, wherein said fingerprint biometric sensor system further comprising:
an input/output port for communicating with an external device; and
a host interface circuit coupled between said buffer and said input/output port to retrieve said stored information from said buffer and communicate a third digital electrical signal to said external device via said input/output port.

80. A method for reducing power consumption of a fingerprint capture device, said method comprising:
forming a fingerprint sensor on a first substrate;
forming device control and signal processing circuits for generating and converting an analog sensor signal carrying fingerprint information to a digital signal on said same first substrate, said signal processing circuits including an analog-to-digital converter; and
forming a buffer memory on said same first substrate, said buffer memory including a plurality of input ports selected to match a bit-width of an analog-to-digital converter.

81. A method for reducing power consumption of a fingerprint capture device, said method comprising:
powering a fingerprint sensor disposed on a first substrate to generate an analog detected signal in response to an externally applied fingerprint stimulus;
receiving said detected signal and processing said detected signal within processing circuits formed on said first substrate to generate an v×p-bit digital signal carrying fingerprint information; and
storing said n-bit fingerprint information in a buffer memory disposed on said first substrate, said buffer memory including a number n of input ports to match said v-bit×p-bit width of said v-bit×p-bit digital fingerprint signal;
said powering, generating, receiving, and storing on said common first substrate and said matching of said v×p-bit widths reducing power consumption of said device relative to devices having an external buffer on a substrate other than said first substrate.

82. The method for reducing power consumption of a fingerprint capture device in claim 81, further comprising: reading said stored q-bit fingerprint information from said buffer and communicating said q-bit fingerprint information to an external device via an interface disposed on said first substrate.
